(19) United States
(12) Patent Application Publication
(10) Pub. No.: US 2017/0280703 A1
(43) Pub. Date: Oct. 5, 2017

(54) POTTY PRO COLLAR SYSTEM

(71) Applicants: Tanner Schnur, Hawkeye, IA (US); Sara Graves, Hawkeye, IA (US)

(72) Inventors: Tanner Schnur, Hawkeye, IA (US); Sara Graves, Hawkeye, IA (US)

(21) Appl. No.: 15/475,132

(22) Filed: Mar. 31, 2017

Related U.S. Application Data
(60) Provisional application No. 62/316,424, filed on Mar. 31, 2016.

(51) Int. Cl. A01M 31/00; G08B 3/10; H04W 4/02; A01K 27/00

(52) U.S. Cl. CPC A01M 31/002; A01K 27/009; A01K 27/001; G08B 3/10; H04W 4/023

(57) ABSTRACT

The Potty Pro Collar System is a pet doorway proximity alert system that alerts a pet owner that a pet is residing near a doorway. The system has a sound indicator, a transmitter, and a proximity collar. The proximity collar is worn around the neck of a pet, and has a tag that couples with the transmitter to signal the sound indicator to sound an audible alert. The pet resides near the interior or exterior of a doorway to create an audible alert. The audible alert volume and sounds are adjustable by buttons on the sound indicator. The present invention is useful to alert a pet owner when a pet desires to urinate outside, and may prevent pets from urinating in the interior of a residence.

### CROSS-REFERENCE TO RELATED APPLICATION

The present application is related to and claims priority from prior provisional application Ser. No. 62/316,424, filed Mar. 31, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of pet alert devices and more specifically relates to a door proximity sound alert system that alerts a pet owner that a pet wearing a collar with a sensor is residing close to the doorway.

### 2. Description of the Related Art

Pet owners of dogs, and other pets that commonly urinate outside know the disadvantages of not letting their pet outside or back inside in a timely manner. If the pet is not let outside, they may urinate on the inside of the residence, scratch at the door, bark, or otherwise cause discomfort to themselves and the pet owner. Similar circumstances may occur when a pet sits or resides directly outside of a doorway and the pet owner or other person is unaware. These are generally undesirable characteristics in pet behavior. As such, a means to alert a pet owner that a pet is residing near the interior or exterior of a doorway is needed.

Various attempts have been made to solve the above-mentioned problems such as those found in U.S. patent and Pub. Nos. U.S. Pat. No. 7,852,224 to Donn Keehn, Sr.; U.S. Pat. No. 5,604,478 to Tamara L. Grady; and 2009/0195393 to Alan Tegeler. This art is representative of door proximity pet alert systems. None of the above inventions and patents, taken either singly or in combination, is seen to describe the invention as claimed.

Ideally, a door proximity pet alert system should operate reliably and be manufactured at a modest expense. Thus, a need exists for a reliable door proximity pet alert system to avoid the above-mentioned problems.

### BRIEF SUMMARY OF THE INVENTION

In view of the foregoing disadvantages inherent in the known art, the present invention provides a novel Potty Pro Collar System; a pet proximity device for facilitating ingress and egress of a pet from a dwelling. The general purpose of the present invention, which will be described subsequently in greater detail is to provide a pet doorway proximity alert system that audibly alerts a user when a pet is residing near a transmitter. The Potty Pro Collar System is comprised of three main parts, the proximity pet collar, the transmitter and the sound indicator. The proximity pet collar is attached to the pet. The transmitter may be attached to a door, doorway, or anywhere a pet may reside when the pet desires to go outside or get back inside a residence. The sound indicator is plugged into an electrical outlet or may be battery operated for mobility and portable use.

The features of the invention which are believed to be novel are particularly pointed out and distinctly claimed in the concluding portion of the specification. These and other features, aspects, and advantages of the present invention will become better understood with reference to the following drawings and detailed description.

The present invention holds significant improvements and serves as a pet doorway proximity alert system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, The Potty Pro Collar System is constructed and operative according to the teachings of the present invention. The Potty Pro Collar System is comprised of three major parts; the proximity pet collar, the transmitter and the sound indicator.

FIG. 1 shows a perspective view illustrating the proximity pet collar, according to an embodiment of the present invention.

FIG. 2 is a side view illustrating the transmitter according to an embodiment of the present invention.

FIG. 3 is a perspective view illustrating the transmitter on a door according to an embodiment of the present invention.

FIG. 4 is a perspective view illustrating the sound indicator according to an embodiment of the present invention.

FIG. 5 is a side view illustrating the sound indicator according to an embodiment of the present invention.

FIG. 6 is an opposite side view illustrating the sound indicator according to an embodiment of the present invention.

The various embodiments of the present invention will hereinafter be described in conjunction with the appended drawings, wherein like designations denote like elements.

### DETAILED DESCRIPTION

As discussed above, embodiments of the present invention relate to a pet doorway proximity alert system and more particularly to The Potty Pro Collar System; a pet access system for facilitating ingress and egress of a pet from a dwelling.

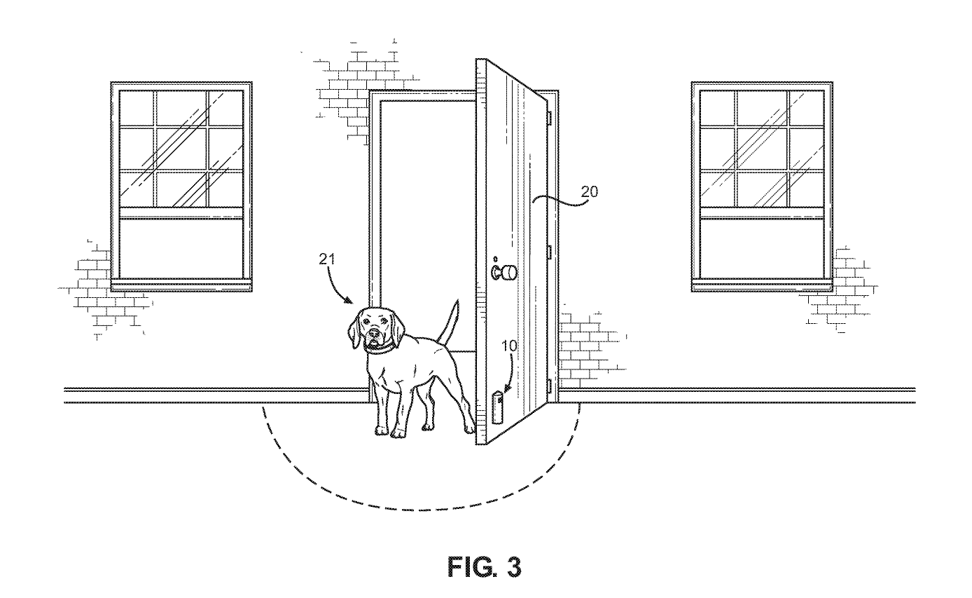

Generally, The Potty Pro Collar System comprises a proximity collar 2, a transmitter 10, and a sound indicator 15. The Potty Pro Collar System alerts the owner if the dog or other pet 21 wants to go outside. Typically, most dogs are taught from a young age to go outside, but the owner may not be right near the door 20 all the time to see when the pet 21 wants to go out. This can lead to accidents near the door 20. The proximity pet collar 2 of the Potty Pro Collar System will react when the pet 21 approaches the transmitter 10 on or near a door. The transmitter 10 will send a signal to the sound indicator 15 which will emit a sound to the owner, alerting them that their pet 21 is by the door 20 and wants to go out. FIG. 3 shows a transmitter 10 attached to a door 20 and a pet 21 nearby.

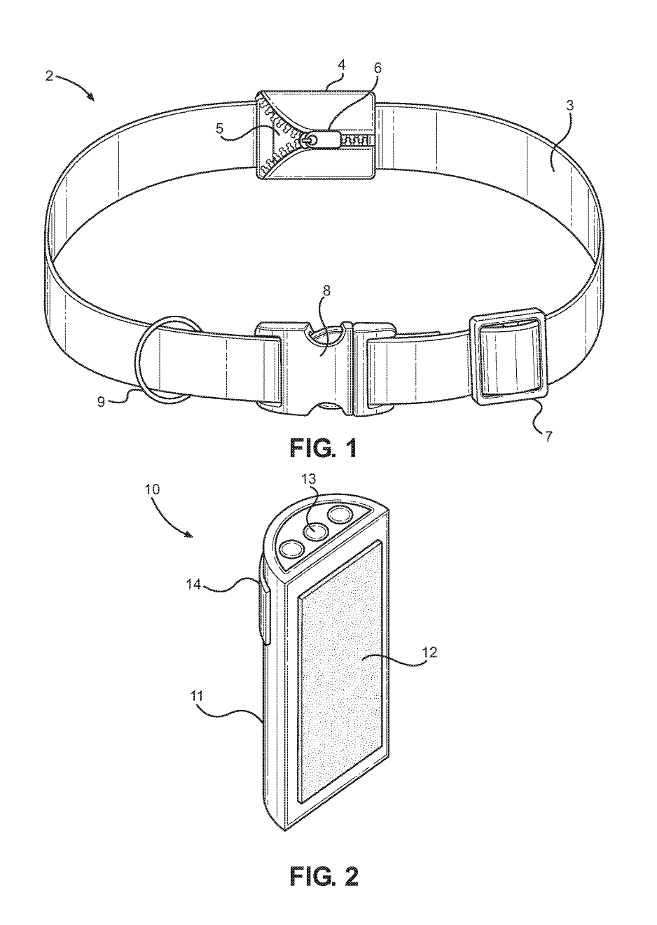

Referring to the drawings by reference numerals there is shown in FIGS. 1-5, a proximity pet collar 2 easily attachable to a multitude of different sized pets 21, a transmitter 10 which is attached to a door 20 or structure near a door 20, and a sound indicator 15 which is plugged into a household electrical outlet 19. sound indicator 15 may also be battery-operated for mobility and portable use. The proximity collar 2 is manufactured of weather resistant material such as heat resistant materials, water resistant materials and waterproofing materials.

The proximity pet collar 2 comprises a strap 3, and a size adjusting member 7 for adjusting the strap 3 to fit different sized pets 21. A leash hook 9 in the form of a D-ring or an O-ring is provided on the strap 3 to receive a pet leash to enable a user to take the pet 21 for a walk if desired and a clip buckle 8 to open and close the strap 3 for putting the proximity collar 2 off and on a pet 21. The proximity pet collar 2 also comprises a tag pouch 4. The tag pouch 4 has an interior and a closeable opening. A zipper 6 is disposed on the opening for permitting access to the interior of the tag pouch 4. The tag pouch 4 contains a tag 5 that holds electronically stored information such as how close the tag 5 is to the transmitter 10. The tag 5 may be manufactured as a passive or active radio-frequency identification (RFID) tag 5. Alternately, the tag 5 may be manufactured of other similar proximity alert indicators. The proximity pet collar 2 may further include a tag battery for operation power in order to transmit a signal from the tag 5.

Usually, active RFID tags are more expensive than passive RFID tags and have environmental limitations due to the presence of the battery. Passive RFID tags do not have an embedded transceiver and battery. They work only when the energy of the EM field generated by a tag reader is sufficient to wake them up. When the proximity collar 2 resides within approximately twenty-four inches of the transmitter 10, the transmitter 10 signals the sound indicator 15 to audibly sound an alert.

The tag 5 within the tag pouch 4 of the proximity collar 2 couples with the transmitter 10 to signal the sound indicator 15 to sound an audible alert. This is useful to alert a pet owner when a pet 21 needs to go outside and may prevent the pet 21 from urinating in the interior of a residence. The tag 5 on the pet 21 alerts the owner when the pet 21 is near the transmitter 10. The transmitter 10 is attached to a door 20, doorway or area where the pet 21 goes out of or into a residence.

Referring now to FIG. 2, the transmitter 10 is shown. The transmitter 10 comprises a transmitter housing 11 containing a radio transmitter and receiver in the form of a tag sensor 14 or tag reader. The tag sensor 14 is configured to send a signal to the tag 5 and read its electrically stored information detailing whether the tag 5 is within twenty-four inches of the transmitter 10 or not. The transmitter 10 may be manufactured as a member of a Radio-frequency Identification (RFID) apparatus. Alternatively, the transmitter 10 may be manufactured to function as a different type of proximity alert indicator. The transmitter 10 reads the electrically stored information from the tag 5 indicating that the tag 5 is within twenty-four inches, the transmitter 10 sends a signal to the sound indicator 15.

The transmitter 10 comprises transmitter batteries 13 to provide functional power and attaches to a door 20 or other appropriate structure where the pet 21 goes in and out by means of a double-sided peel and stick adhesive strip tape 12. The transmitter 10 is manufactured of weather resistant material such as heat resistant materials, water resistant materials and waterproofing materials.

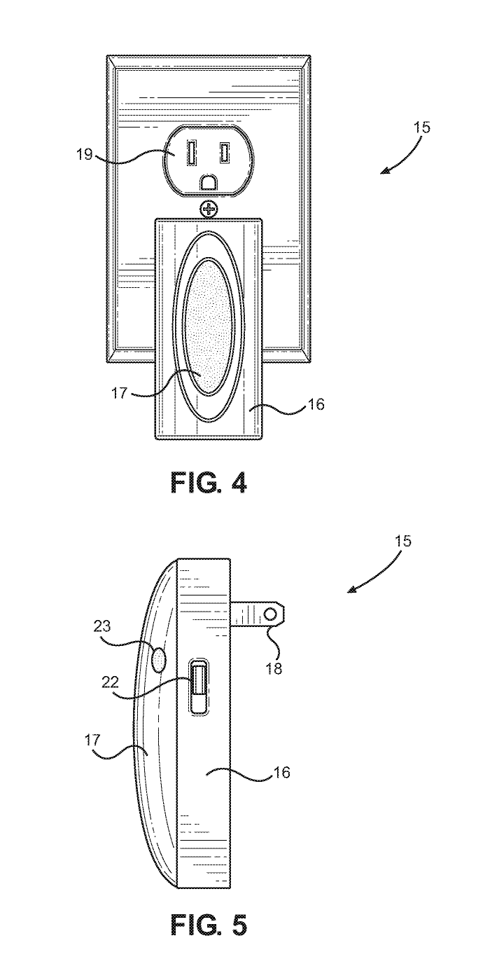

Referring now to FIG. 4, the sound indicator 15 is shown. The sound indicator 15 comprises a sound indicator housing 16 having a front and a back side. The speaker 17 is on the front side of the sound indicator housing 16 and a receiver 23 resides on either the inside or the outside of the housing 16. Outlet prongs 18 reside on the back side of the housing for plugging into a household outlet 19 which provides electrical energy for the speaker 17. Sound indicator 15 as stated previously may also be battery operated to provide mobility and allow portability. Sound indicator 15 may have one or multiple audible alert sounds to choose from which the user may select via the sound indicator 15.

FIG. 5 shows a side view of the sound indicator 15. The speaker 17 for emitting sound and is loud enough to be heard within a residence and includes a volume control mechanism 22 so that a user can adjust the volume and type of sound as desire or to turn off.

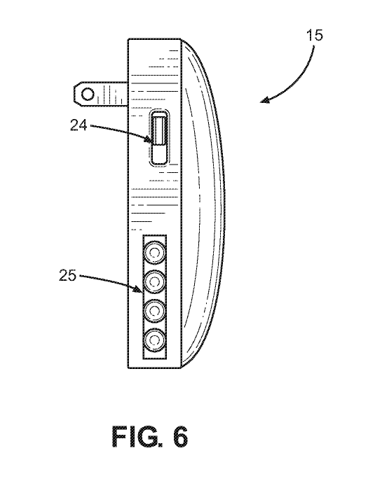

FIG. 6 shows an opposite side view of the sound indication 15 illustrating an on/off switch 24 and a battery slot 25.

In operation, a user first determines the door 20 or doorways where pets 21 go outside or inside of a residence. Next the transmitter 10 is placed on or near the door 20 using the double sided adhesive tape 12. The proximity collar 2 is then placed on the pet 21, adjusted to the proper size by the size adjusting member 7 and closed with the clip buckle 8. The tag 5 is zipped into the pouch 4 on the strap 3 of the proximity collar 2. After that, the user determines where the sound indicator 15 should be placed within the household and the sound indicator 15 is then inserted in a household outlet 19 by means of the outlet prongs 18 (or battery-powered) (on the back of the sound indicator housing 16. The volume control 22 on the side of the sound indicator housing 16 is then adjusted to choose the volume and type of sound.

Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A pet collar proximity system for facilitating the ingress and egress of a pet from a dwelling comprising:
an elongated strap configured for encircling the neck of said pet;
a pouch secured to said elongated strap, said pouch defining an interior and having a closable opening for permitting access to said interior;
a tag configured to hold electronically stored information, said tag being disposed within said interior of said pouch;
a transmitter housing comprising a tag sensor, said tag sensor configured to read said electronically stored information and in response to reading said stored information transmit a signal;
a sound indicator housing comprising a speaker configured to sound an audible alert, said sound indicator housing further comprising a receiver configured to receive said signal and sound said audible alert.

2. The pet collar proximity system of claim 1, wherein said closeable opening comprises a zipper for permitting access to said interior of said pouch.

3. The pet collar proximity system of claim 1, wherein said elongated strap comprises two opposed ends connected by a buckle.

4. The pet proximity collar system of claim 1, wherein said elongated strap comprises a size adjusting member for adjusting a length of said elongated strap.

5. The pet proximity collar system of claim 1, wherein said elongated strap comprises a leash hook for receiving a pet leash.

6. The pet proximity collar system of claim 1, wherein said tag is an RFID tag.

7. The pet proximity collar system of claim 1, wherein said transmitter housing comprises adhesive for mounting said transmitter housing on or near a door.

8. A pet collar proximity collar system for facilitating ingress and egress of a pet from a dwelling comprising:
a proximity collar comprising a strap having two opposed ends for encircling the neck of a pet, a size adjusting member for adjusting a length of said strap, a leash hook for receiving a pet leash, a clip buckle for joining said two opposed ends of said strap, a tag pouch on said strap, said tag pouch having an interior, a zipper for opening and closing said tag pouch and an RFID tag holding electronic information, said RFID tag being received within said tag pouch;
a transmitter comprising a transmitter housing, said transmitter housing containing a tag sensor for reading said electronic information transmitted from said RFID tag, a transmitting device for transmitting an electronic signal to a sound indicator, batteries for providing power to said tag sensor, double sided adhesive tape for attaching said transmitter housing to or near a door;
a sound indicator comprising a sound indicator housing, said sound indicator housing containing a receiver for receiving said electronic signal from said transmitting device, a speaker for emitting sound in response to said electronic signal from said transmitting device, outlet prongs for plugging into a household outlet for receiving power from said outlet for powering said receiver and said speaker, a volume control mechanism for adjusting the volume and type of sound emitting from said speaker,
whereby a user is able to identify by sound emitted from said speaker when said pet is near said door so that said pet may be let inside or outside of said dwelling.

9. The pet proximity collar system of claim 8, wherein said RFID tag is passive.

10. The pet proximity collar system of claim 8, wherein said RFID tag is active and wherein said tag pouch further includes a battery for powering said RFID tag.

11. The pet proximity collar system of claim 8, wherein said proximity collar and said transmitter are comprised of weather resistant materials.

12. The pet proximity collar system of claim 8, wherein said transmitter and said speaker are activated when said RFID tag resides within twenty-four inches of said transmitter.
